(19) United States
(12) Patent Application Publication
(10) Pub. No.: US 2019/0194950 A1
(43) Pub. Date: Jun. 27, 2019

(54) Surface Covering Element for Integrating an Electrically Powered Electronic Device into a Surface Covering

(71) Applicant: Tarkett GDL, Lentzweiler (LU)

(72) Inventor: Christophe Reithler, Wiltz (LU)

(21) Appl. No.: 16/328,981

(22) PCT Filed: Aug. 30, 2017
(86) PCT No.: PCT/EP2017/071789

§ 371 Date: Feb. 27, 2019

Related U.S. Application Data
(60) Provisional application No. 62/381,873, filed on Aug. 31, 2016.

(51) Int. Cl. E04F 13/08; E04F 15/02; H02G 3/38

(52) U.S. Cl. CPC E04F 13/0889; E04F 2290/02; H02G 3/385; E04F 15/02044

(57) ABSTRACT

The invention relates to surface covering elements for integrating at least one electronic device electrically powered by conductive circuit in a surface covering. The surface covering element comprises at least one, preferably at least two, electrically conductive strip conductors arranged within the surface covering element between its front and back surfaces and at least one recess opening into the back surface between so as to uncover the at least one electrically conductive strip conductor over a certain length. The at least one recess may comprise one or more device recesses and/or one or more connector recesses. Any device recess is preferably placed within the interior of the back face area, whereas any connector recess is preferably placed at an edge of the back face area.

### TECHNICAL FIELD

The present invention generally relates to surface covering elements to be used more particularly for covering floor surfaces, wall surfaces or ceiling surfaces in buildings. It relates more particularly to a surface covering element suitable for integrating electrically conductive circuits in such surface coverings. A preferred embodiment of the present invention concerns synthetic surface covering elements, more particularly synthetic flooring elements and, in particular, thin synthetic flooring elements. cl BACKGROUND

Surface covering elements are well known in the art. They basically comprise tiles (i.e. substantially equilateral rectangular elements), panels (i.e. oblong rectangular elements), bands or rolls (which have a width in the range of 8 cm to 500 cm and a length of several meters or even a few tens of meters). The thickness of these different elements is in the range of 2 mm to 20 mm. If their thickness is in the range of 1 mm to 8 mm, the surface covering elements are called hereinafter “thin” surface covering elements. They are made of synthetic polymer materials (such as PVC, polyolefins, polyesters, polyamides), of natural resins (e.g. linoleum), of rubber, of mineral material, of wood based material or a composite made from these material. They may comprise substantial amounts of different filler materials. It will further be noted that such flooring elements may consist of only one homogeneous layer, which will then have to fulfil different functions (such as a support function, a choc absorbing and/or isolating function, a decorative function, a wear resistant function), or they may be multi-layered elements comprising superposed functional layers, such as a backing layer, a decorative layer, a wear layer. They may be rigid elements, resilient elements or flexible elements. When they are used as a decorative flooring, the flooring elements often include a decorative pattern, for example abstract patterns or patterns imitating the aesthetic appearance of natural floorings such as wood or stone floorings. When they are used as an underlay flooring, a decorative pattern is of course not required. These flooring elements may be adhesively fixed to the floor, for example glued onto the floor surface to be covered or fixed by means adhesive tapes or sheets. However, if their side edges are equipped with conjugate connection profiles, such as a tongue profile (or male profile) and a groove profile (or female profile), for mechanically interlocking the flooring elements, they may also be loosely laid on the floor to be covered.

A problem underlying the present invention is to use such flooring elements for integrating into surface coverings electronic devices that are electrically powered by conductive circuits.

### SUMMARY OF THE INVENTION

The invention relates to surface covering elements for integrating at least one electronic device electrically powered by conductive circuit in a surface covering. The surface covering element comprises at least one, preferably at least two, electrically conductive strip conductors arranged within the surface covering element between its front and back surfaces and at least one recess opening into the back surface between so as to uncover the at least one electrically conductive strip conductor over a certain length. The at least one recess may comprise one or more device recesses and/or one or more connector recesses. Any device recess is preferably placed within the interior of the back face area, whereas any connector recess is preferably placed at an edge of the back face area.

A first aspect of the invention relates to a surface covering element (e.g. a tile, a plank, a sheet, a band, or the like) for integrating at least one electronic device, e.g. a transmitter, a transponder, a positioning system beacon, a charging point (e.g. for mobile devices), a wireless network access point, a lighting device, a sensor, a display device, etc., electrically powered by a conductive circuit in a surface covering. The surface covering element has a back surface and a front surface, a first edge and a second edge and comprises: at least one electrically conductive strip conductor arranged within the surface covering element between the back surface and the front surface; and at least one device recess opening into the back surface between the first edge and the second edge, so as to uncover the at least one electrically conductive strip conductor over a certain length. The device recess is configured and arranged to house the electronic device.

The surface covering element preferably further includes an electronic device housed in the device recess, this electronic device including at least one device contact that is in electrical contact with the at least one electrically conductive strip conductor arranged within the surface covering element.

The electronic device preferably includes: a device box having a front surface and a back surface; at least one device contact located on the front surface; a recess cover affixed to the back surface of the device box, wherein the recess cover is slightly greater than the back surface and forms an outwardly projecting rim, which is affixed in a sealed manner to a corresponding rim surface surrounding the device recess, so that the recess cover is flush with the back surface of the surface covering element. The seal formed between the device and the surface covering element is preferably liquid-tight in order to protect the electronics from water spilled on the surface covering, other liquids or humidity.

Preferably, the electronic device is supplied with electric energy through at least two electrically conductive strip conductors arranged side by side within the surface covering element.

According to embodiments, the electronic device could be an active beacon for indoor positioning, or an active sensor, such as a pressure sensor, a temperature sensor, a humidity sensor, a capacitive or inductive proximity sensor, or a signal transmitter or receiver.

A second aspect of the invention relates to a surface covering element for integrating an electronic device electrically powered by a conductive circuit in a surface covering, the surface covering element having a back surface and a front surface, a first edge and a second edge. The surface covering element comprises: at least one electrically conductive strip conductor arranged within the surface covering element between the back surface and the front surface so as to be substantially parallel to these surfaces and to extend between the first edge and the second edge to have a first end located close to the first edge and a second end located close to the second edge; and a first connector recess opening into the back surface and into the first edge, so as to uncover the first end of the at least one electrically conductive strip conductor.

The surface covering element according to the second inventive aspect preferably further comprises a second connector recess opening into the back surface and into the second edge, so as to uncover the second end of the at least one electrically conductive strip conductor.

The surface covering element according to the second inventive aspect preferably may further comprise a connector chip having a first end and a second end, wherein its first end is received in the first connector recess and its second end protrudes from the first edge (for engagement with a neighbouring surface covering element).

The connector chip preferably includes:
a flat support piece, having a first end and a second end, a back surface and a front surface;
a first connector chip contact on the first end of the flat support piece, the first connector chip contact being arranged on the front surface so as to be in electrical contact with the first end of the at least one electrically conductive strip conductor arranged within the surface covering element;
a second connector chip contact on the second end of the flat support piece, the second connector chip contact being located on the front surface so as to form an upwardly directed contact surface on the second end of the connector chip near the first edge; and
   an electrical conductor interconnecting the first connector chip contact and the second connector chip contact.

The connector chip could also include a connector chip contact arranged on the first end of the connector chip so as to be electrically in contact with the first end of the at least one electrically conductive strip conductor arranged within the surface covering element; and a connection cable coming out of the second end of the connector chip, wherein it is electrically connected to the connector chip contact arranged on the first end of the connector chip.

According to an embodiment, the connector chip has its first end fixed by means of adhesive material within the first connector recess, so as to seal the first connector recess against penetration of liquids and humidity.

The connector chip mounted in the first connector recess preferably has a back surface that is flush with the back surface of the surface covering element.

The surface covering element according to the second inventive aspect may further include at least one device recess opening into the back surface between the first edge and the second edge, so as to uncover the at least one electrically conductive strip conductor over a certain length. It follows that the first and second inventive aspects may be cumulated.

The surface covering element (according to the first and/or the second inventive aspect), preferably has a thickness of less than 10 mm, more preferably of less than 8 mm, most preferably of less than 6 mm.

The connector and device recesses preferably have a depth in the range of 2 mm to 6 mm, more preferably in the range of 2 mm to 5 mm and most preferably in the range of 2 mm to 4 mm.

The connector and device recesses could have a depth that is 1 mm to 3 mm smaller than the thickness of the surface covering element.

The surface covering element could comprise at least two electrically conductive strip conductors arranged side by side within the surface covering element.

The surface covering element could be a decorative surface covering tile, a decorative surface covering panel or a decorative surface covering band.

Alternatively, the surface covering element could be used in an underlayer surface covering.

The surface covering element could be made on the basis of synthetic polymer materials or of natural resins or of rubber.

According to an embodiment, a surface covering element for building electrically conductive circuits in floor coverings is presented. The surface covering element has a front surface, a back surface, a length, two long edges and two short edges and comprises:
at least one electrically conductive strip conductor arranged between the front surface and the back surface, wherein it extends over the length of the surface covering element;
at least one device recess opening into the back surface, so that it uncovers the at least one electrically conductive strip conductor over a certain length.

The surface covering element may further include an electronic device housed in at least one device recess, this electronic device including at least one device contact that is in electric contact with the at least one electrically conductive strip conductor arranged within the surface covering element.

The surface covering element could further include a connector recess opening into the back surface and into one of the short edges of the surface covering element, so as to uncover an end of the at least one electrically conductive strip conductor.

The surface covering element could further include a connector chip having a first end and a second end, wherein its first end is received in the first connector recess and a connection cable coming out of the second end of the connector chip.

The surface covering element as described anywhere above could be a floor covering element, preferably a thin floor covering element and, most preferably, a thin synthetic floor covering element.

An embodiment of the invention relates to a surface covering, in particular a floor covering, with active beacons for precise (indoor) positioning built with surface covering elements as described anywhere hereinabove.

A further embodiment of the invention relates to a set of surface covering elements for integrating an electrically conductive circuit in a surface covering. The set may comprise surface covering elements according to the first aspect and/or according to the second aspect. Preferably, the set includes surface covering elements including all or some of the features recited described hereinabove.

### BRIEF DESCRIPTION OF DRAWINGS

The afore-described and other features, aspects and advantages of the invention will be better understood with regard to the following description of several embodiments of the invention and upon reference to the attached drawings, wherein:

FIG. 1 is a top view schematically illustrating a tile floor covering including two electric circuits built with flooring elements;

FIG. 2 is a top view schematically illustrating a continuous floor covering including two electric circuits built with further embodiments of flooring elements;

FIG. 3 is a plan view of the back surface of a flooring element;

FIG. 4 is a plan view as in FIG. 3, further showing a connector chip and an electronic device integrated into the flooring element;

FIG. 5 is a 3D view showing a connector chip in front of a connector recess of a flooring element;

FIG. 6 is a 3D view as in FIG. 5, showing the connector chip housed in the connector recess of the flooring element, which is shown here as a transparent body;

FIG. 7 is a 3D view showing an electronic device to be housed in a flooring element, wherein the view is from the front side;

FIG. 8 is a 3D view as in FIG. 7, wherein the view is from the back side;

FIG. 9 is a transversal section through a device recess in a flooring element, wherein an electronic device is housed in the device recess;

FIG. 10 is a transparent 3D view of such a device recess (viewed through the front surface of the tile) illustrating how the electronic device contacts in the device recess two electrically conductive strip conductors; and

FIG. 11 is a 3D view showing the back surface of two interconnected flooring panels and of a flooring element in accordance with the present invention.

### DETAILED DESCRIPTION OF AN EMBODIMENT OF THE INVENTION

It will be understood that the following description and the drawings to which it refers describe by way of example embodiments of the invention for illustration purposes. They shall not limit the scope, nature or spirit of the claimed subject matter.

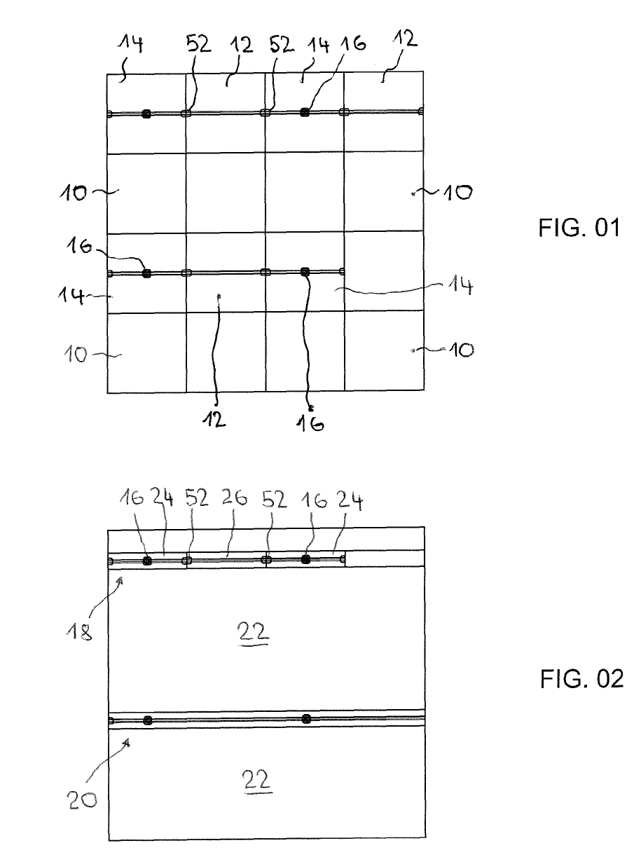

FIG. 1 is a top view schematically illustrating a tile floor covering composed of flooring tiles of, for example, 50 cm by 50 cm (typical side dimensions are in the range of 30 cm to 150 cm). It will be noted that the tiles could also have other shapes (e.g. a polygonal shape or a circular shape and in general any other shape as long as they can be juxtaposed to build a continuous path.) The thickness of such flooring tiles is usually in the range of 1 mm to 8 mm, preferably in the range of 2 mm to 8 mm. They are made of synthetic polymer materials (such as PVC, polyolefins, polyesters, polyamides), of natural resins (e.g. linoleum) or of rubber and may comprise different kinds of filler materials. Three types of flooring tiles are used in this floor covering. The flooring tiles 10 are classic flooring tiles, i.e. flooring tiles not including any kind of electric circuit material. The flooring tiles 12 are electricity conveying flooring tiles, which are essentially responsible for conveying electricity from one tile to the other (i.e. they include electric conductors). The flooring tiles 14 are device flooring tiles including, in addition to the electric conductors of the electricity conveying flooring tiles 12, an electronic device 16, as for example an active beacon for indoor positioning or for positioning in an outdoor environment equipped with the tile flooring. The upper row of flooring tiles comprises for example a first device flooring tile 14 connected by means of an electricity conveying flooring tile 12 to a second device flooring tile 14, which is connected to a second electricity conveying flooring tile 12.

FIG. 2 is a top view schematically illustrating a floor covering comprising two bands 18, 20 composed of flooring elements, which are integrated into an otherwise continuous flooring 22, but could also be incorporated into a tile or panel flooring. The band 18 is more precisely composed of four flooring panels, wherein the first and the third flooring panels are device flooring panels 24, similar to the device flooring tiles 14, the second flooring panel is an electricity conveying flooring panel 26, similar to the electricity conveying flooring tiles 12, and the fourth flooring panel is a classic flooring panel 28, i.e. a flooring panel not including any kind of electric circuit material. The band 20 includes two electronic devices 16, but there is of course no limitation as regards the number of electronic devices 16. The band 20 preferably consists of a thin synthetic flooring band, normally having a width in the range of 8 cm to 50 cm and a length of several meters (in some cases even a few tens of meters).

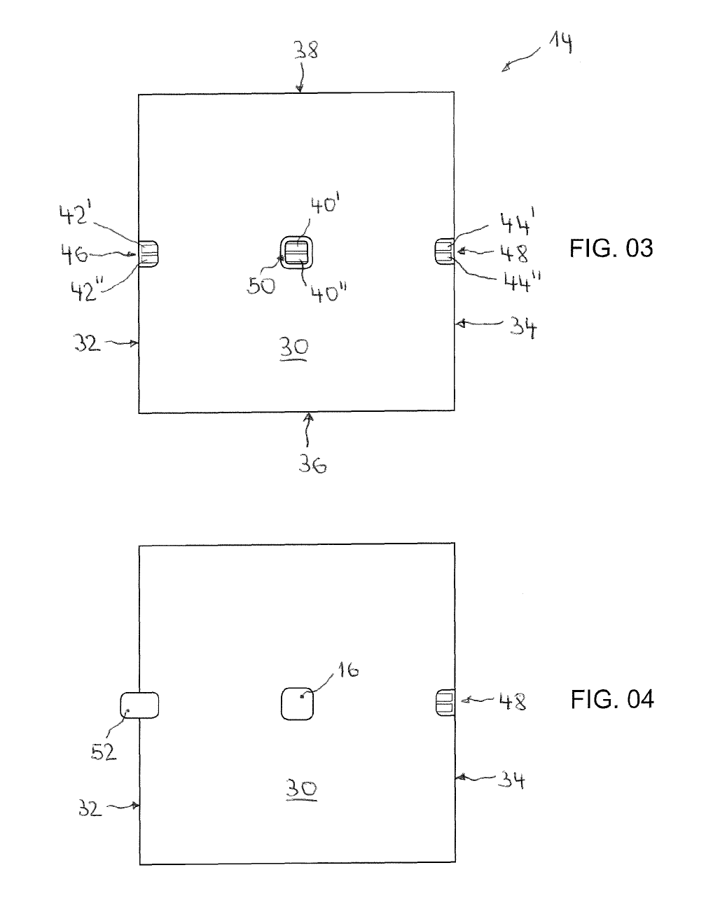

The basic structure of a device flooring tile 14 or a device flooring panel 24 will now be described with reference to FIG. 3. This flooring element 14 has a back surface 30 (which is seen in the figure) and a front surface (which is not seen in the figure), a first edge 32, a second edge 34, a third edge 36 and a fourth edge 38. Two electrically conductive strip conductors 40′, 40″ are arranged within the flooring element 14, 24 between the back surface and the front surface. They are substantially parallel to these surfaces and extend between the first edge 32 and the second edge 34, wherein each of the strip conductors 40′, 40″ has a first end 42′, 42″ located close to the first edge 32 and a second end 44′, 44″ located close to the second edge 34. In a preferred embodiment, these electrically conductive strip conductors 40′, 40″ are thin copper strips. The electrically conductive strip conductors 40′, 40″ normally have a thickness in the range of 0.01 mm to 0.5 mm and a width in the range of 5 mm to 15 mm, and are preferably spaced by a distance in the range of 2 mm to 6 mm. The electrically conductive strip conductors may also be or comprise printed conductors (obtained by printing a conductive ink). The thickness of such conductors could, e.g., be comprised in the range from 1 μm to 100 μm.

A first connector recess 46 opens into the back surface 30 and the first edge 32, so as to uncover the first ends 42′, 42″ of the two electrically conductive strip conductors 40′, 40″ and to provide a substantially rectangular embayment in the first edge 32. A second connector recess 48 opens into the back surface 30 and the second edge 34, so as to uncover the second ends 44′, 44″ of the two electrically conductive strip conductors 40′, 40″ and to provide a substantially rectangular embayment in the second edge 34. A central device recess 50 opens into the back surface substantially in the centre of the flooring tile 14, so as to uncover the two electrically conductive strip conductors 40′, 40″ over a certain length. The recesses 46, 48, 50 are essentially invisible from the top side (front surface) of the device flooring panel.

FIG. 4 shows the same flooring element 14 as FIG. 3, wherein a connector chip 52 is mounted in the first connector recess 46 and the electronic device 16 is mounted into the central device recess 50.

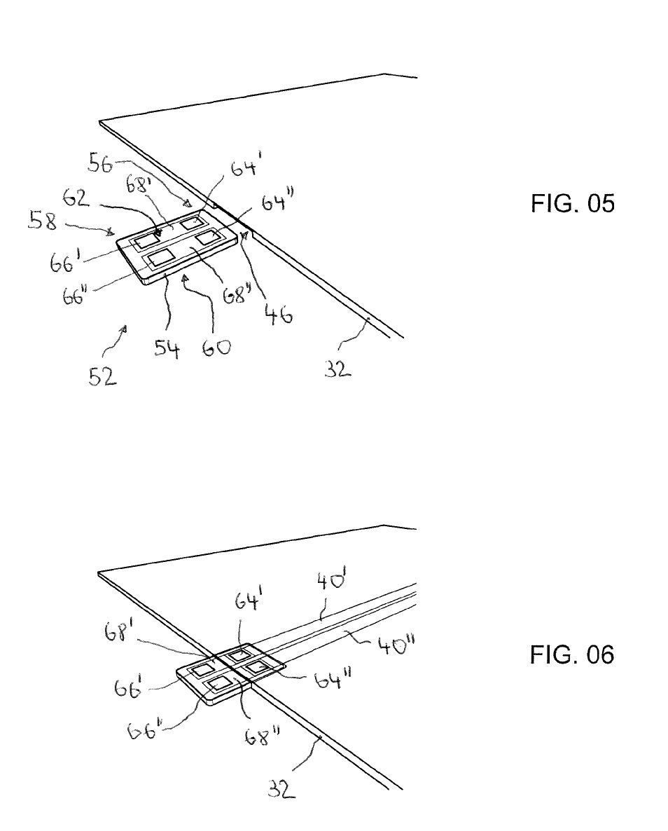

FIGS. 5 and 6 illustrate the connector chip 52 in greater detail. It comprises a flat chip-like support piece 54, having a substantially rectangular form (preferably with rounded corners) with a first end 56 and a second end 58, a back surface 60 and a front surface 62. Both ends 56 and 58 are designed to provide a positive fit with a connector recess 46, 48. On the first end 52 of the flat support piece 54, two first connector chip contacts 64′, 64″ are arranged on the front surface 62, so as to be in electrical contact with the first ends of the two electrically conductive strip conductors 40′, 40″ arranged within the flooring element 14, when the first end of the connector chip 52 is received in the first connector recess 46 (see FIG. 6). On the second end 58 of the flat support piece 54, which protrudes from the first edge 32 when the first end of the connector chip 52 is received in the first connector recess 46 (see FIG. 6), two second connector chip contacts 66′, 66″ are located on the front surface 62 so as to form two upwardly directed contact surfaces on the protruding end of the connector chip 50 near the first edge 32. Electrical conductors 68′, 68″, which are advantageously embedded in the chip-like support piece 54, interconnect the first connector chip contacts 64′, 64″ and the second connector chip contacts 66′, 66″. The front surface 62 of the connector chip 52 is, with the exception of the first and second connector chip contacts 64′, 64″, 66′, 66″, advantageously provided with an adhesive material that allows fixing the connector chip 52 in the corresponding connector recesses 46, 48 and sealing these recesses against penetration of liquids and humidity. When the connector chip 52 is mounted in the connector recess 46, it has its back surface 60 flush with the back surface 30 of the flooring element 14.

It will be noted that each of the connector and device recesses 46, 48, 50 has a depth in the range of 2 mm to 6 mm, preferably in the range of 2 mm to 5 mm and most preferably in the range of 2 mm to 4 mm. In general, the connector and device recesses have a depth that is 1 mm to 3 mm smaller than the thickness of the flooring element (see in particular FIG. 9). This also means that in the flooring element 14, the electrically conductive strip conductors 40′, 40″ are spaced 2 mm to 6 mm from the back surface 30 of the flooring element 14 and 1 mm to 3 mm from the front surface of the flooring element 14.

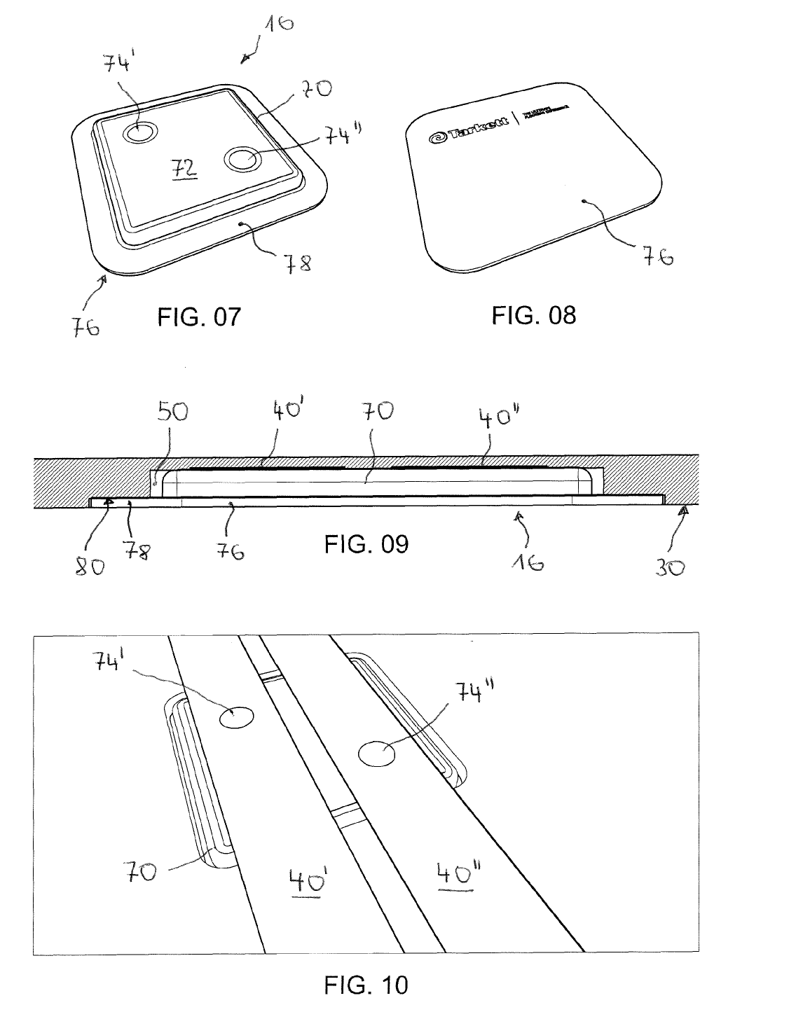

FIGS. 7 to 10 illustrate an electronic device 16 to be fitted into the central device recess 50. This electronic device 16 advantageously includes a watertight device box 70 having a front surface 72 and an opposite back surface (see FIG. 7). Two electrical device contacts 74′, 74″ are located on the front surface 72 of the device box 70. As seen in FIG. 10, these two device contact 74′, 74″ contact the electrically conductive strip conductors 40′, 40″ when the electronic device 16 is fitted into the central device recess 50. A recess cover 76 is affixed to the back surface of the device box 70, wherein the recess cover 76 is slightly greater than this back surface and forms an outwardly projecting rim 78. This rim 78 is affixed in a sealed manner to a corresponding rim surface 80 surrounding the device recess 50, so that the recess cover 76 is flush with the back surface 30 of the flooring element 14 (see in particular FIG. 9).

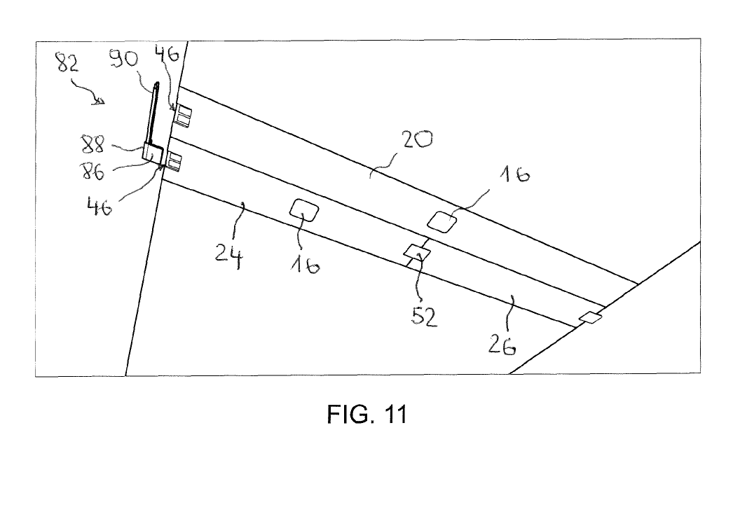

FIG. 11 shows the back surfaces of two interconnected flooring panels 24 and 26, as well as the back surface of a band-shaped flooring element 20 with one electronic device 16 integrated therein. (Such a band-shaped flooring element 20 may of course include n (>1) electronic devices 16, which are spaced along its length.) Reference number 82 globally identifies a connector chip that may be used at the periphery of the floor covering for connecting the electric circuit integrated in the flooring elements to an external electric circuit (as e.g. an electric power supply). The connector chip 82 has a first end 86 and a second end 88, wherein its first end 86 is designed as the first end of the connector chip 52, to be received in the connector recess 46. A connection cable 90 comes out of the second end 88 of the connector chip 82.

It will be appreciated that the proposed flooring elements can be advantageously used for integrating electrically conductive circuits in a floor covering and, in particular, in a thin floor covering. They allow in particular to build a floor covering with active beacon for indoor positioning.

Reference signs list

| | |
|---|---|
| 10 | classic flooring tiles |
| 12 | electricity conveying flooring tile |
| 14 | device flooring tile |
| 16 | electronic device in 14 |
| 18 | band of flooring elements |
| 20 | band of flooring elements |
| 22 | continuous flooring |
| 24 | device flooring panel |
| 26 | electricity conveying flooring panel |
| 28 | |
| 30 | back surface of 14 |
| 32 | first edge of 14 |
| 34 | second edge of 14 |
| 36 | third edge of 14 |
| 38 | fourth edge of 14 |
| 40′, | electrically conductive strip |
| 40″ | conductors |
| 42′, | first end of 40′, 40″ |
| 42″ | |
| 44′, | second end of 40′, 40″ |
| 44″ | |
| 46 | first connector recess |
| 48 | second connector recess |
| 50 | central device recess |
| 52 | connector chip |
| 54 | flat chip-like support piece |
| 56 | first end of 54 |
| 58 | second end of 54 |
| 60 | back surface of 54 |
| 62 | front surface of 54 |
| 64′, | first connector chip contacts |
| 64″ | |
| 66′, | second connector chip |
| 66″ | contacts |
| 68′, | electrical conductors |
| 68″ | |
| 70 | device box |
| 72 | front surface of 70 |
| 74′, | electrical device contacts |
| 74″ | |
| 76 | recess cover |
| 78 | outwardly projecting rim |
| 80 | corresponding rim surface |
| 82 | connector chip |
| 86 | first end of 82 |
| 88 | second end of 82 |
| 90 | connection cable |

1. A surface covering element for integrating at least one electronic device electrically powered by conductive circuit in a surface covering, the surface covering element having a back surface and a front surface, a first edge and a second edge and comprises:
at least one electrically conductive strip conductor arranged within the surface covering element between said back surface and said front surface; and
at least one device recess opening into said back surface between said first edge and said second edge, so as to uncover the at least one electrically conductive strip conductor over a certain length.

2. The surface covering element as claimed in claim 1, further including:
an electronic device housed in the device recess, this electronic device including at least one device contact that is in electrical contact with the at least one electrically conductive strip conductor arranged within the surface covering element.

3. The surface covering element as claimed in claim 2, wherein the electronic device includes:
a device box having a front surface and a back surface;
at least one device contact located on said front surface;
a recess cover affixed to said back surface of the device box, wherein the recess cover is slightly greater than said back surface and forms an outwardly projecting rim, which is affixed in a sealed manner to a corresponding rim surface surrounding the device recess, so that the recess cover is flush with said back surface of the surface covering element.

4. The surface covering element as claimed claim 1, wherein the electronic device is supplied with electric energy through at least two electrically conductive strip conductors arranged side by side within the surface covering element.

5. The surface covering element as claimed in claim 4, wherein the electronic device is an active beacon for indoor positioning, or an active sensor, such as a pressure sensor, a temperature sensor, a humidity sensor, a capacitive or inductive proximity sensor, or a signal transmitter or receiver.

6. A surface covering element for integrating an electronic device electrically powered by conductive circuit in a surface covering, the surface covering element having a back surface and a front surface, a first edge and a second edge and comprising:
at least one electrically conductive strip conductor arranged within the surface covering element between said back surface and said front surface so as to be substantially parallel to these surfaces and to extend between said first edge and said second edge to have a first end located close to said first edge and a second end located close to said second edge; and
a first connector recess opening into said back surface and into said first edge, so as to uncover said first end of the at least one electrically conductive strip conductor.

7. The surface covering element as claimed in claim 6, further comprising:
a second connector recess opening into said back surface and into said second edge, so as to uncover said second end of the at least one electrically conductive strip conductor.

8. The surface covering element as claimed in claim 6, further comprising:
a connector chip having a first end and a second end, wherein its first end is received in said first connector recess and its second end protrudes from said first edge.

9. The surface covering element as claimed in claim 8, wherein the connector chip includes:
a flat support piece, having a first end and a second end, a back surface and a front surface;
a first connector chip contact on said first end of the flat support piece, said first connector chip contact being arranged on said front surface so as to be in electrical contact with said first end of the at least one electrically conductive strip conductor arranged within the surface covering element;
a second connector chip contact on said second end of the flat support piece, said second connector chip contact being located on said front surface so as to form an upwardly directed contact surface on said second end of the connector chip near said first edge; and
an electrical conductor interconnecting said first connector chip contact and said second connector chip contact.

10. The surface covering element as claimed in claim 8, wherein the connector chip includes:
a connector chip contact arranged on said first end of the connector chip so as to be electrically in contact with said first end of the at least one electrically conductive strip conductor arranged within the surface covering element;
a connection cable coming out of said second end of the connector chip, wherein it is electrically connected to the connector chip contact arranged on said first end of the connector chip.

11. The surface covering element as claimed in claim 8, wherein the connector chip has its first end fixed by means of adhesive material within said first connector recess, so as to seal said first connector recess against penetration of liquids and humidity.

12. The surface covering element as claimed in claim 8, wherein the connector chip mounted in said first connector recess has a back surface that is flush with said back surface of the surface covering element.

13. The surface covering element as claimed in claim 6, further including at least one device recess opening into said back surface between said first edge and said second edge, so as to uncover the at least one electrically conductive strip conductor over a certain length.

14. The surface covering element as claimed in claim 1, having a thickness of less than 10 mm, preferably less than 8 mm, most preferably less than 6 mm.

15. The surface covering element as claimed in claim 1, wherein the connector and device recesses have a depth in the range of 2 mm to 6 mm, preferably in the range of 2 mm to 5 mm and most preferably in the range of 2 mm to 4 mm.

16. The surface covering element as claimed in claim 1, wherein the connector and device recesses have a depth that is 1 mm to 3 mm smaller than the thickness of the surface covering element.

17. The surface covering element as claimed in claim 1, comprising at least two electrically conductive strip conductors arranged side by side within the surface covering element.

18. The surface covering element as claimed in claim 1, which is a decorative surface covering tile, a decorative surface covering panel or a decorative surface covering band.

19. The surface covering element as claimed claim 1, which is used in an underlayer surface covering.

20. The surface covering element as claimed in claim 1, which is made on the basis of synthetic polymer materials or of natural resins or of rubber.

21. A surface covering element for building electrically conductive circuits in floor coverings, having a front surface, a back surface, a length, two long edges and two short edges and comprising:
at least one electrically conductive strip conductor arranged between said front surface and said back surface, wherein it extends over the length of the surface covering element;
at least one device recess opening into said back surface, so that it uncovers the at least one electrically conductive strip conductor over a certain length.

22. The surface covering element as claimed in claim 21, further including an electronic device housed in at least one device recess, this electronic device including at least one device contact that is in electric contact with the at least one electrically conductive strip conductor arranged within the surface covering element.

23. The surface covering element as claimed in claim 21, further including a connector recess opening into said back surface and into one of said short edges of the surface covering element, so as to uncover an end of the at least one electrically conductive strip conductor.

24. The surface covering element as claimed in claim 21, further including a connector chip having a first end and a second end, wherein its first end is received in said first connector recess and a connection cable coming out of said second end of the connector chip.

25. The surface covering element as claimed in claim 1 which is a floor covering element, preferably a thin floor covering element and, most preferably, a thin synthetic floor covering element.

26. A surface covering, in particular a floor covering, with active beacons for precise indoor positioning built with surface covering elements as claimed in claim 1.

27. (canceled)
